(19) United States
(12) Patent Application Publication
(10) Pub. No.: US 2019/0069353 A1
(43) Pub. Date: Feb. 28, 2019

(54) Dimpled Wok

(71) Applicants: David R. Hall, Provo, UT (US); Pamela Bennett Barnes, Provo, UT (US); Jason Mortensen, Provo, UT (US); Joe Fox, Spanish Fork, UT (US)

(72) Inventors: David R. Hall, Provo, UT (US); Pamela Bennett Barnes, Provo, UT (US); Jason Mortensen, Provo, UT (US); Joe Fox, Spanish Fork, UT (US)

(21) Appl. No.: 15/684,004

(22) Filed: Aug. 23, 2017

(51) Int. Cl. H05B 6/12; A47J 27/00; A47J 37/10

(52) U.S. Cl. CPC H05B 6/1227; F24C 3/08; A47J 37/10; A47J 27/004

(57) ABSTRACT

The invention is a dimpled wok. A wok, or any other bowl-shaped cooking surface, is fitted with one or more discrete cooking surfaces along the inner sloping walls. The discrete cooking surfaces, which are containers for food, may be bowl-shaped, creating “dimples” in the pan, or they may be oval with flat bottoms, or they may resemble a shelf. The discrete cooking surfaces have lower cooking temperatures than the bottom and walls of the pan. This allows food to be pushed, conveniently and easily, away from the high-temperature cooking that takes place at the bottom of the pan, and into the separate discrete cooking surfaces, where the food may be held to be warmed, and not overcooked. The dimpled wok may be an electric wok, equipped with a central heating element, or a heating element in each of the dimples.

### TECHNICAL FIELD

This invention relates generally to the field of cooking appliances, and more specifically to cooking pans.

### BACKGROUND

The wok, a traditional round-bottomed, bowl-shaped cooking pan, has been used for thousands of years in China. It has been used for a variety of cooking techniques, including stir frying, steaming, pan frying, deep frying, boiling, stewing, and roasting. In recent decades, woks have become more and more prevalent throughout the rest of the world as well, becoming a staple in most kitchens where Asian cooking is done. The unique benefit of a wok, as opposed to other basic cookware, is that the concave shape produces a small, hot area at the bottom that allows food to be seared by intense heat while using relatively little fuel. The curved sides make it unnecessary to “chase food around the pan” because ingredients usually tumble back to the center of the wok, where the heat is concentrated, when they are agitated.

However, this same benefit becomes a disadvantage for the unexperienced cook. Foods, such as meat and vegetables, require varied cooking times and temperatures. If such foods are mingled together, equally and simultaneously exposed to the high temperatures at the bottom of the wok, the foods that cook more quickly may become overcooked, burned, tough, or soggy. To avoid this, effort must be made to time the cooking so that the foods that cook quickly are added later or removed earlier, which can be a hassle. For this reason, novice cooks trying out their newest piece of cookware often find the wok too difficult to manipulate, so that it soon becomes just a designer piece sitting on a shelf.

This problem, however, can be solved by carefully considering the design of the wok. Current wok designs have been adjusted for other purposes, such as for use on flat electric stoves. Some woks have been designed so that the concave bottom can fit within a custom heating device. However, no current wok designs have addressed the problem of varied cooking temperatures.

In light of the foregoing, what is needed is a wok with holding surfaces that have cooler temperatures, so that foods of varying consistencies can be easily exposed to or removed from the center of heat at different times without being removed from the pan. In this way, the benefits of the wok's shape are preserved while even the most inexperienced cooks can easily manipulate the pan to best advantage.

### SUMMARY OF THE INVENTION

The disclosed invention has been developed in response to the present state of the art and, in particular, in response to the problems and needs in the art that have not yet been fully solved by currently available components and methods. Accordingly, efficient structural components and methods have been developed to allow for a wok with holding surfaces that have cooler temperatures.

Consistent with the foregoing, a wok-style pan is disclosed. The wok-style pan comprises a bowl-shaped cooking surface comprising a bottom portion, an intermediate portion, and a rim portion. The intermediate portion comprises a continuous raised interior wall joining the bottom portion and the rim portion. The continuous raised interior wall comprises one or more discrete cooking surfaces disposed thereon. Cooking temperatures of the one or more discrete cooking surfaces are lower than cooking temperatures of the bottom portion and the intermediate portion of the bowl-shaped cooking surface.

In different embodiments, the bottom portion may comprise a concave or a planar surface. The bowl-shaped cooking surface may comprise an exterior with one or more handles, which may be loop-style or stick-style. The one or more discrete cooking surfaces may comprise depressions in the intermediate portion opening into the interior of the pan. The one or more discrete cooking surfaces may be bowl-shaped, or they may be oval depressions with a flattened bottom surface, or they may comprise a shelf along an interior surface of the intermediate portion. The wok-style pan may comprise varying numbers of discrete cooking surfaces, such as two, four, or six. The wok-style pan may be equipped with a central heating element, and/or a heating element in each of the dimples, making it an electric wok.

### BRIEF DESCRIPTION OF THE DRAWINGS

A more particular description of the invention briefly described above is made below by reference to specific embodiments depicted in drawings included with this application, in which:

FIG. 1 depicts one embodiment of the wok-style pan;

FIG. 2A depicts a side view of one embodiment of a wok-style pan with a bottom portion comprising a concave surface;

FIG. 2B depicts a side view of one embodiment of a wok-style pan with a bottom portion comprising a planar surface;

FIG. 3A depicts one embodiment of a wok-style pan comprising one or more discrete cooking surfaces that are substantially bowl-shaped, opening into the interior of the wok-style pan;

FIG. 3B depicts one embodiment of a wok-style pan comprising one or more discrete cooking surfaces comprising a substantially oval depression comprising a flattened bottom surface;

FIG. 3C depicts one embodiment of a wok-style pan comprising one or more discrete cooking surfaces comprising a shelf along an interior surface of the intermediate portion of the bowl-shaped cooking surface;

FIG. 4A depicts one embodiment of a wok-style pan comprising four discrete cooking surfaces;

FIG. 4B depicts one embodiment of a wok-style pan comprising two discrete cooking surfaces;

FIG. 5 depicts one embodiment of a wok-style pan with some foods cooking on the bottom portion and other foods separated into the one or more discrete cooking surfaces;

FIG. 6A depicts one embodiment of a wok-style pan with a hot plate;

FIG. 6B depicts a front view of one embodiment of an electric wok-style pan comprising a heating element;

FIG. 6C depicts a bottom view of one embodiment of an electric wok-style pan comprising a heating element; and

FIG. 7 depicts one embodiment of a wok-style pan comprising one or more lids.

### DETAILED DESCRIPTION

A detailed description of the claimed invention is provided below by example, with reference to embodiments in the appended figures. Those of skill in the art will recognize that the components of the invention as described by example in the figures below could be arranged and designed in a wide variety of different configurations. Thus, the detailed description of the embodiments in the figures is merely representative of embodiments of the invention, and is not intended to limit the scope of the invention as claimed.

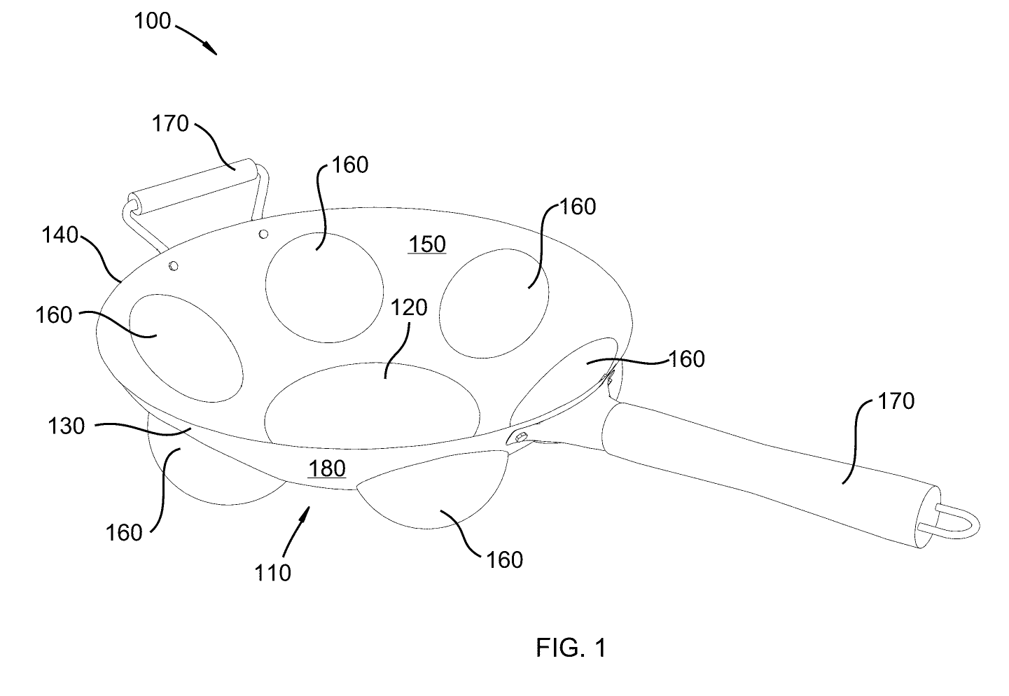

FIG. 1 depicts one embodiment of a wok-style pan 100. The wok-style pan 100 comprises a bowl-shaped cooking surface 110. A bowl-shaped cooking surface is a surface, usually metal, in the shape of a bowl—or in other words, rounded with a gentle inclination on all sides toward a central area—that heats up when exposed to heat, such that food can be cooked thereon. In one embodiment, the bowl-shaped cooking surface 110 is a wok. The bowl-shaped cooking surface 110 may, in certain embodiments, comprise cast iron, or carbon steel, or stainless steel, or a combination thereof. In other embodiments, the bowl-shaped cooking surface 110 may comprise another metal, glass, or another material. In some embodiments, the bowl-shaped cooking surface 110 comprises an interior coating, such as Teflon, silicon, or ceramic. In some embodiments, the bowl-shaped cooking surface 110 comprises an exterior enamel covering, which may be in one or more of a variety of colors.

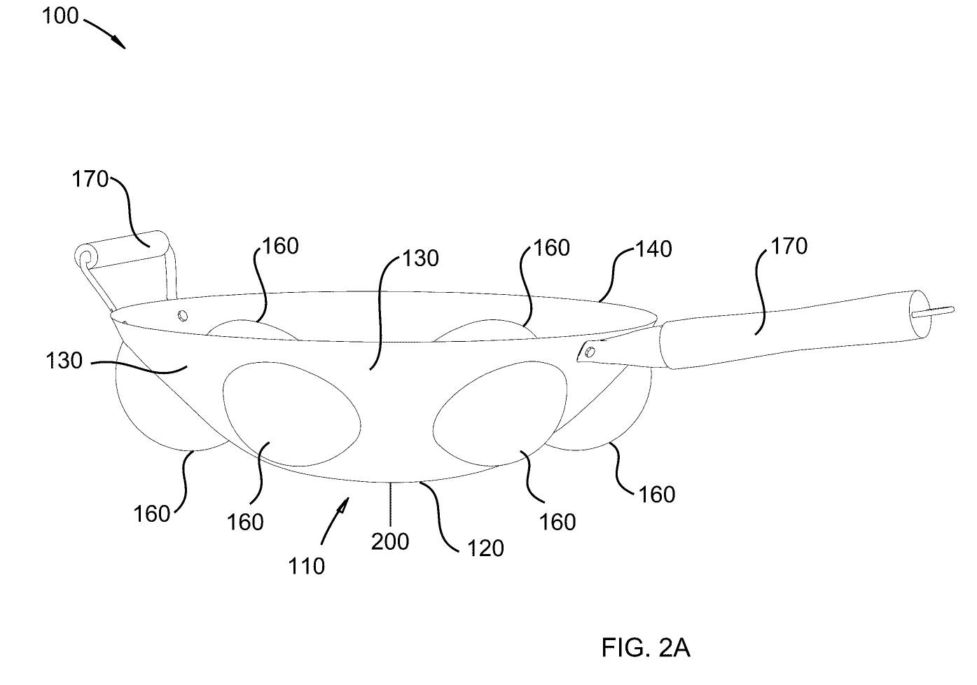

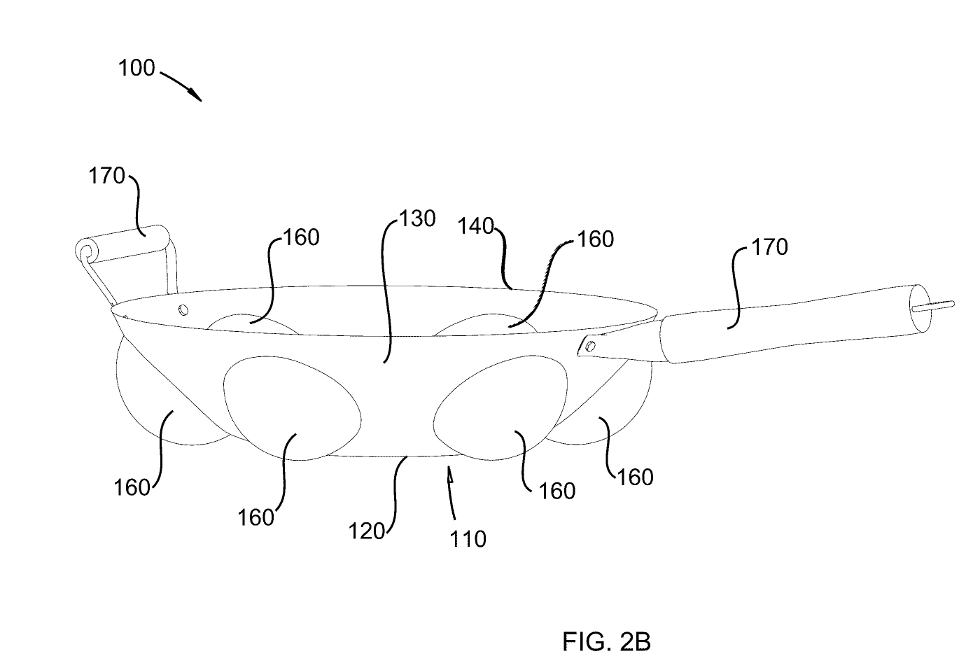

The bowl-shaped cooking surface 110 comprises a bottom portion 120, an intermediate portion 130, and a rim portion 140. The bottom portion 120 is the bottom-most surface of the bowl-shaped cooking surface 110. It holds food particles or other objects inside the wok-style pan 100. The bottom portion 120 is exposed directly to a heat source and is thus the portion of the bowl-shaped cooking surface 110 that reaches the highest temperature. In one embodiment, the bottom portion 120 comprises a concave surface, as depicted in FIG. 2A. In another embodiment, the bottom portion 120 comprises a planar surface, as depicted in FIG. 2B. The rim portion 140 comprises a top edge of the bowl-shaped cooking surface 110. In one embodiment, the rim portion 140 is in a circular configuration with a diameter of approximately 14 inches. The rim portion 140 may be configured to accommodate a lid for the wok-style pan 100. The intermediate portion 130 of the bowl-shaped cooking surface 110 comprises a continuous raised interior wall 150 joining the bottom portion 120 and the rim portion 140. In one embodiment, the continuous raised interior wall 150 inclines from the rim portion 140 to the bottom portion 120 at a concave slope. In one embodiment, the continuous raised interior wall 150 extends entirely around the bowl-shaped cooking surface 110. In one embodiment, the continuous raised interior wall 150 extends entirely around the bowl-shaped cooking surface 110 at an even and equal slope. In one embodiment, the continuous raised interior wall 150 is smooth. The continuous raised interior wall 150 comprises one or more discrete cooking surfaces 160 disposed thereon. Cooking temperatures of the one or more discrete cooking surfaces 160 are lower than cooking temperatures of the bottom portion 120 and the intermediate portion 130 of the bowl-shaped cooking surface 110.

In one embodiment, the bowl-shaped cooking surface 110 is three to ten inches deep, preferably five inches deep, measured vertically from the rim portion 140 to the bottom portion 120. In one embodiment, the bowl-shaped cooking surface 110 is approximately between 8-20 inches, preferably 14 inches, in diameter at the rim portion 140, and approximately between 3-10 inches, preferably between 7-8 inches, in diameter at the bottom portion 120. In one embodiment, the bowl-shaped cooking surface 110 comprises an exterior surface 180 comprising one or more handles 170. The one or more handles 170 may comprise wood, plastic, or metal. In one embodiment, the one or more handles 170 are loop-style handles. In another embodiment, the one or more handles 170 are stick-style handles. In one embodiment, the one or more handles 170 are positioned adjacent the rim portion 140. In one embodiment, two handles 170 are positioned directly opposite each other adjacent the rim portion 140. In one embodiment, one loop-style handle and one stick-style handle are positioned directly opposite each other adjacent the rim portion 140. In another embodiment, two loop-style handles are positioned directly opposite each other adjacent the rim portion 140.

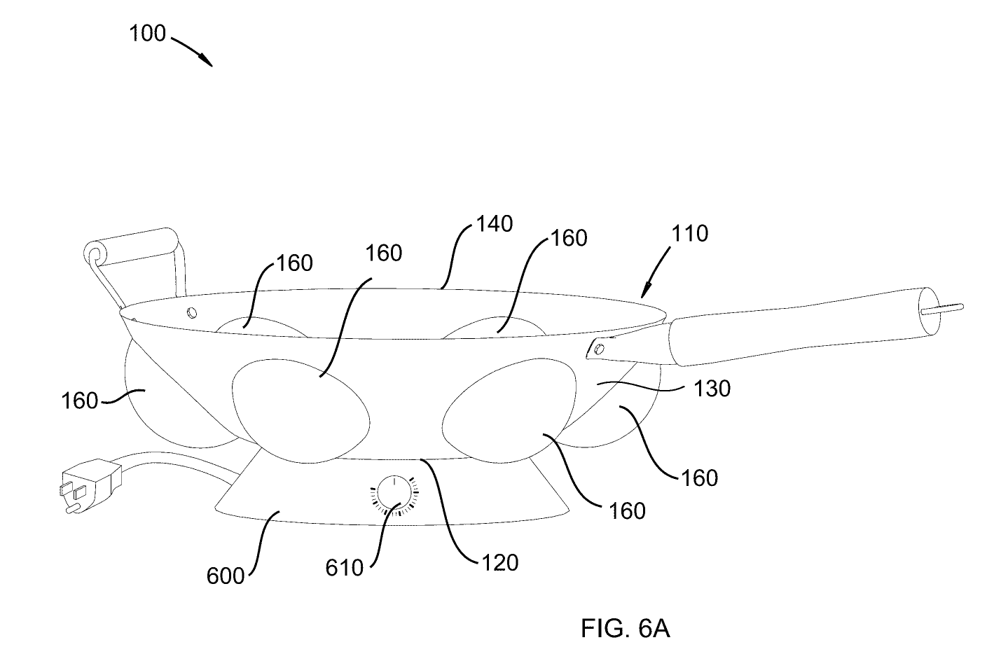

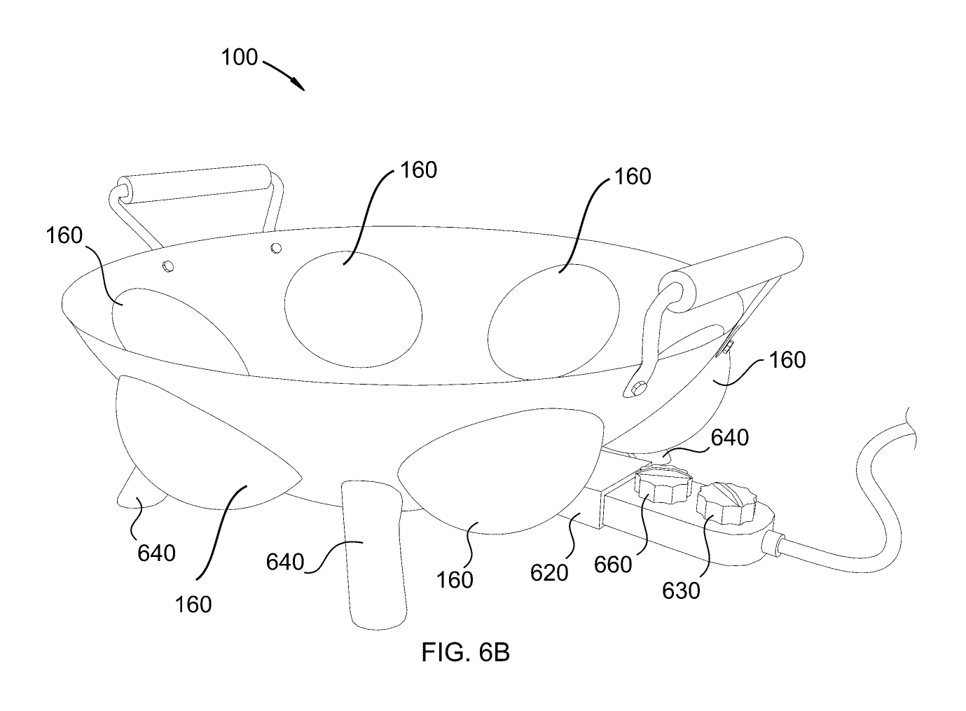

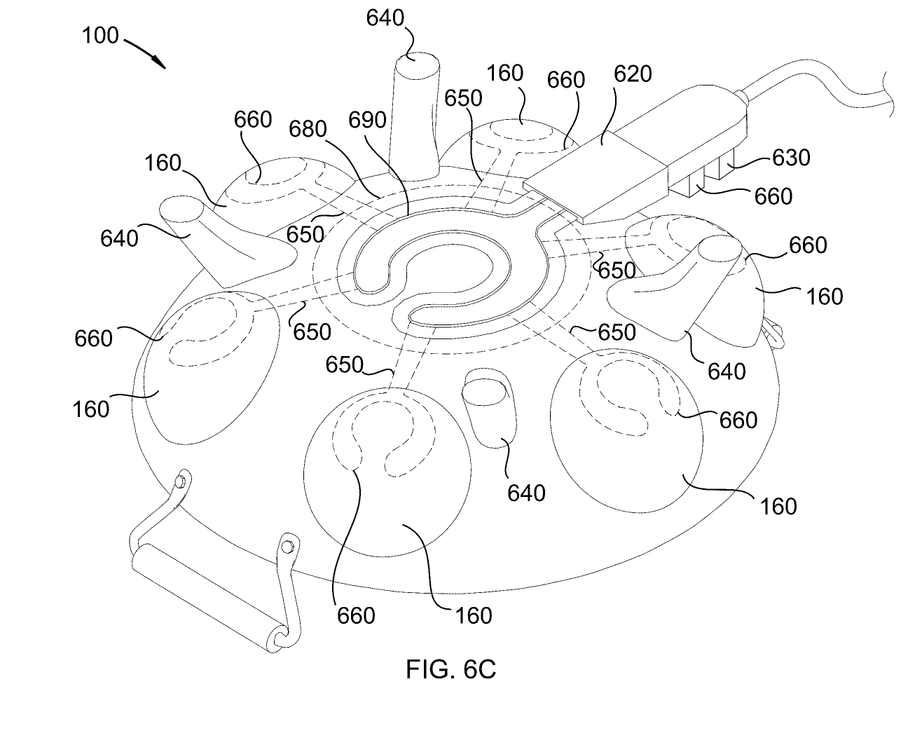

FIG. 2A depicts a side view of one embodiment of a wok-style pan 100 with a bottom portion 120 comprising a concave surface. In this embodiment, the bottom portion 120 slopes continuously toward one central, bottom-most point 200 that has a diameter of approximately less than one inch, as in the rounded bottom of a traditional Chinese wok. This prevents the wok-style pan 100 from resting levelly without support on a flat surface such as a stove top. However, this embodiment of the wok-style pan 100 can be used on a stove top by using a wok rack or ring, or it can be used over a fire, or with a custom heating device, as depicted in FIG. 6A-FIG. 6C.

FIG. 2B depicts a side view of one embodiment of a wok-style pan 100 with a bottom portion 120 comprising a planar surface. In this embodiment, the bottom portion 120 is flattened horizontally, preferably across a circular area with a diameter of approximately 7 to 8 inches. This embodiment allows the wok-style pan 100 to be placed levelly on a flat surface, such as a stove top, without additional support.

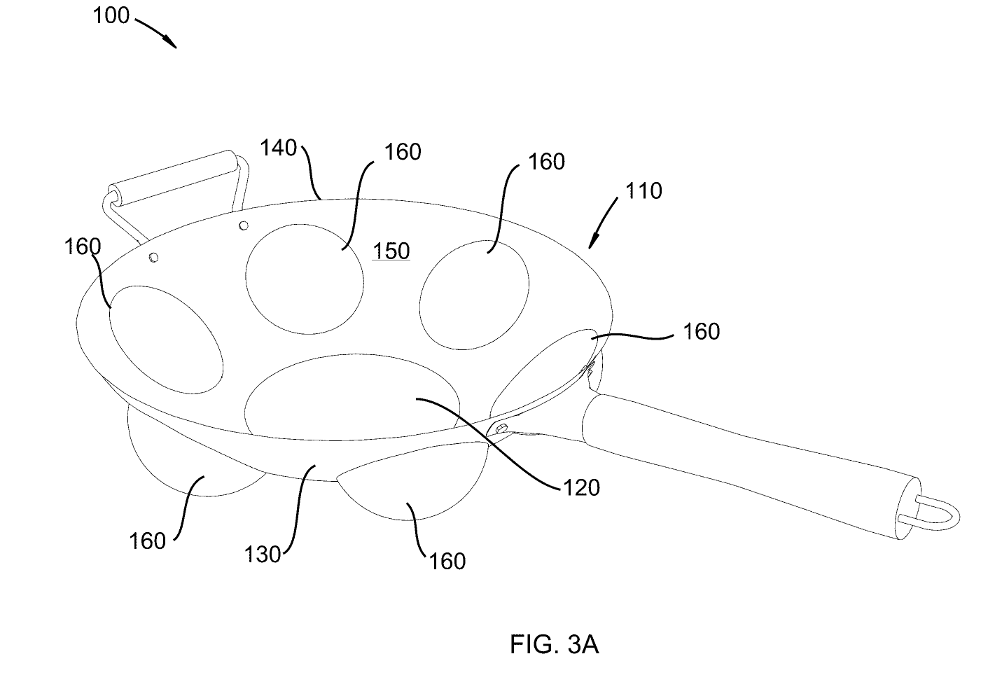

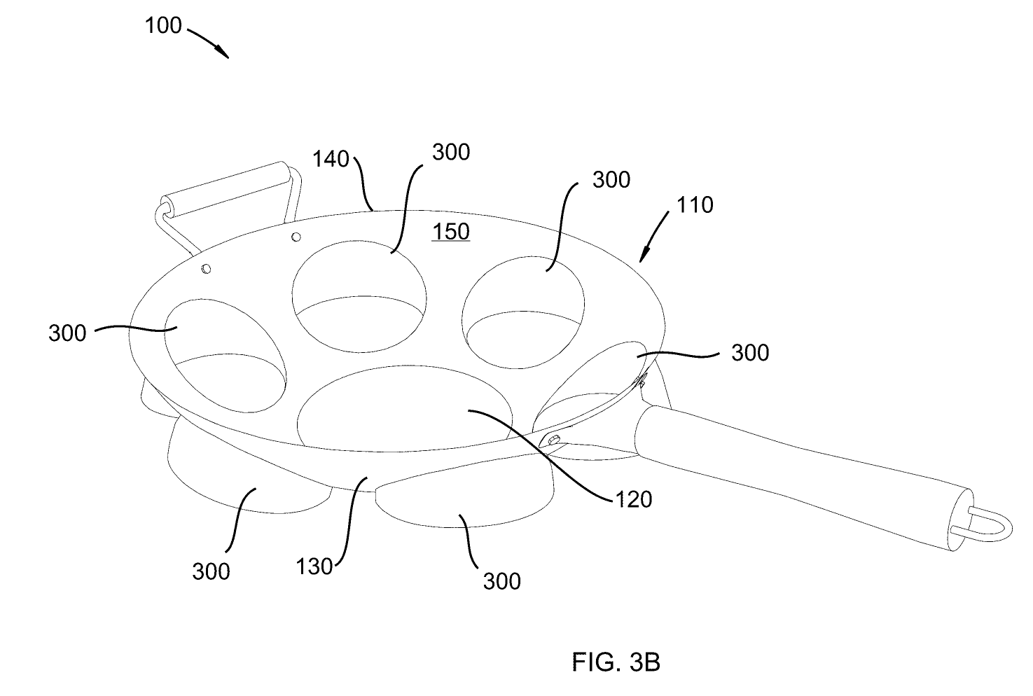

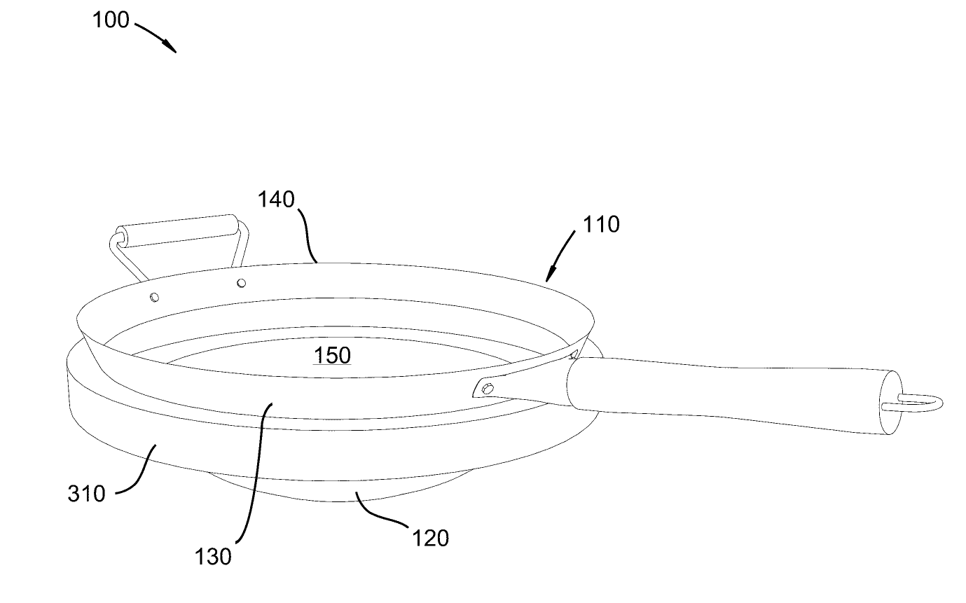

FIG. 3A-FIG. 3C depict embodiments of the wok-style pan 100 comprising a bowl-shaped cooking surface 110 comprising an intermediate portion 130 comprising a continuous raised interior wall 150 comprising one or more discrete cooking surfaces 160 disposed thereon. In one embodiment, the one or more discrete cooking surfaces 160 comprise depressions in the intermediate portion 130 opening into the interior of the wok-style pan 100. In this embodiment, the one or more discrete cooking surfaces 160 extend outward from the bowl-shaped cooking surface 110, preferably from between approximately 1 to 5 inches. In one embodiment, the one or more discrete cooking surfaces 160 are formed out of the same one solid piece of material as the bowl-shaped cooking surface 110, whether carbon steel, stainless steel, cast iron, or another material. In one embodiment, each of the one or more discrete cooking surfaces 160 constitute containers that hold objects, such as food particles, separate and apart from the contents contained by the bottom portion 120 of the bowl-shaped cooking surface 110. In one embodiment, the one or more discrete cooking surfaces 160 each have a volume of between about one-third cup to five cups. Each of the one or more discrete cooking surfaces 160 is large enough to contain and hold food particles, such as cut vegetables or meat. The one or more discrete cooking surfaces 160 may have numerous possible configurations.

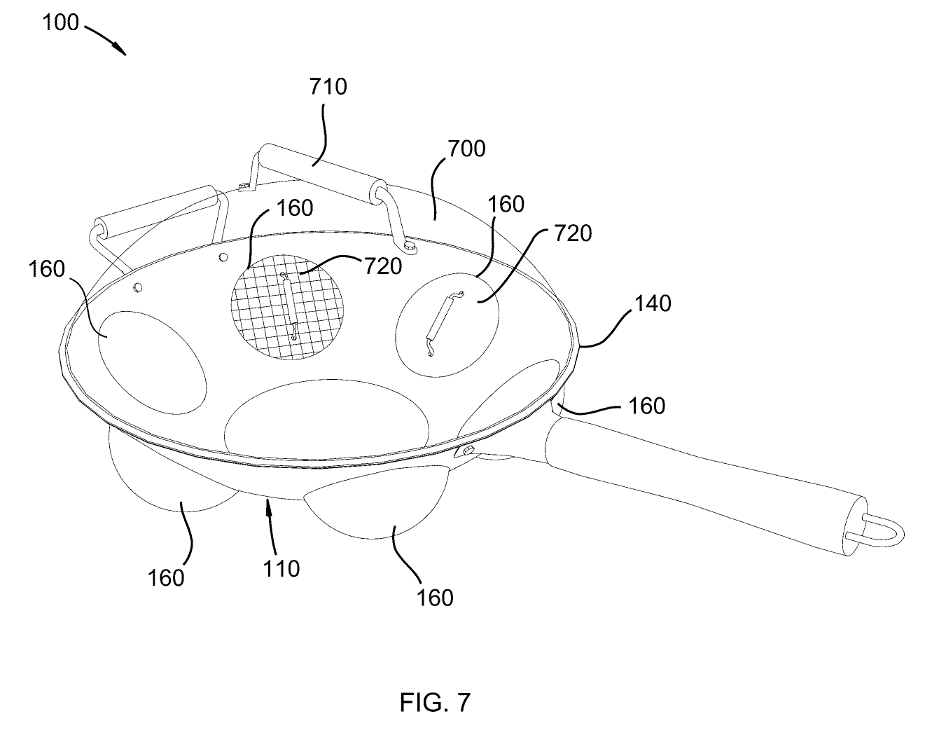

In one embodiment, the one or more discrete cooking surfaces 160 in the intermediate portion 130 are substantially bowl-shaped, opening into the interior of the wok-style pan 100. This embodiment is depicted in FIG. 3A. In this embodiment, walls of the substantially bowl-shaped one or more discrete cooking surfaces 160 are rounded with a gentle inclination on all sides toward a central area. The substantially bowl-shaped one or more discrete cooking surfaces 160 resemble “dimples” in the bowl-shaped cooking surface 110. In this embodiment, each of the one or more discrete cooking surfaces 160 may have a diameter of approximately between 2 to 10 inches. Each of the one or more discrete cooking surfaces 160 may have a depth of between approximately 1 to 5 inches at a central point. Each of the one or more discrete cooking surfaces 160 may be fitted with a lid, as depicted in FIG. 7. In another embodiment, the one or more discrete cooking surfaces 300 comprise a substantially oval depression comprising a flattened bottom surface. This embodiment is depicted in FIG. 3B. The flattened bottom surface is planar. Each of the one or more discrete cooking surfaces 300 in this embodiment may have a depth of between approximately 1 to 5 inches measured across the flattened bottom surface. Each of the one or more discrete cooking surfaces 300 may be fitted with a lid, as depicted in FIG. 7. In another embodiment, the one or more discrete cooking surfaces 310 comprise a shelf along an interior surface of the intermediate portion 130. This embodiment is depicted in FIG. 3C. The shelf may be rectangular. The shelf may be planar, and it may extend out from the bowl-shaped cooking surface 110 between approximately one to three inches.

Cooking temperatures of the one or more discrete cooking surfaces 160 are lower than cooking temperatures of the bottom portion 120 and the intermediate portion 130 of the bowl-shaped cooking surface 100. In one embodiment, cooking temperatures of the one or more discrete cooking surfaces 160 are warming temperatures. In one embodiment, cooking temperatures of the one or more discrete cooking surfaces 160 are about 140 degrees Fahrenheit. In one embodiment, cooking temperatures of the one or more discrete cooking surfaces 160 are approximately 140 degrees Fahrenheit or higher, up to the cooking temperatures of the bottom portion 120 and the intermediate portion 130. In one embodiment, cooking temperatures of the one or more discrete cooking surfaces 160 are substantially lower than cooking temperatures of the bottom portion 120 and the intermediate portion 130, from between approximately 25 degrees to 250, when the wok-style pan 100 is exposed to a single heat source. The one or more discrete cooking surfaces 160 are exposed only to indirect heat when the bottom portion 120 is exposed to direct heat. This allows raw ingredients to remain only slightly cooked when placed in the one or more discrete cooking surfaces 160, until retrieved from the one or more discrete cooking surfaces 160 and removed to the bottom portion 120 of the wok-style pan 100 to be cooked at higher temperatures. Therefore, foods that may need to be cooked for shorter times can still be placed in the wok-style pan 100 at the same time as longer-cooking foods, but are not overcooked, if they are separated into the one or more discrete cooking surfaces 160. Furthermore, ingredients that have been cooking at the bottom portion 120 may be removed to the one or more discrete cooking surfaces 160 to remain heated, without continuing to overcook within the bottom portion 120 with other ingredients that may need to cook longer.

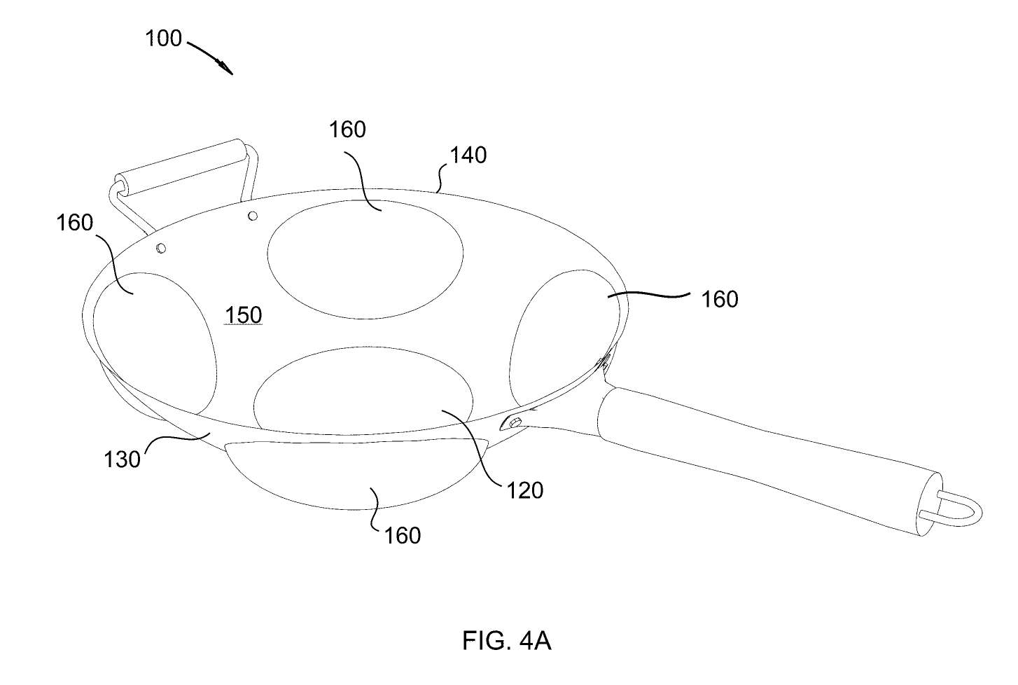

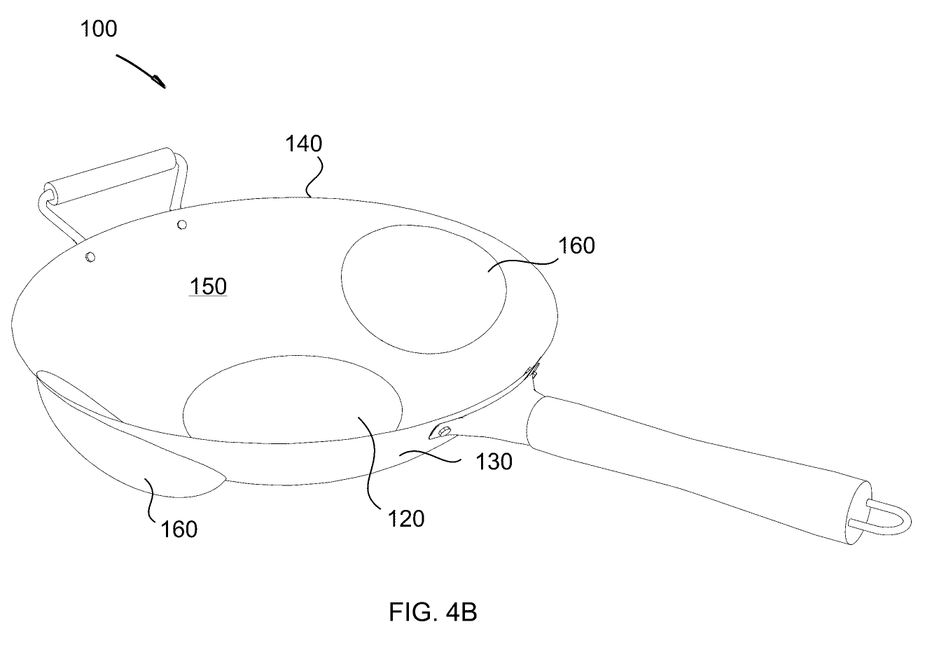

FIG. 4A and FIG. 4B depict embodiments of the wok-style pan 100 comprising varying numbers of discrete cooking surfaces 160. In one embodiment, the wok-style pan 100 comprises four discrete cooking surfaces 160, as depicted in FIG. 4A. In another embodiment, the wok-style pan 100 comprises two discrete cooking surfaces 160, as depicted in FIG. 4B. In another embodiment, the wok-style pan 100 comprises six discrete cooking surfaces 160, as was depicted in FIG. 1. Other embodiments have a higher or lower number of discrete cooking surfaces 160. In embodiments with fewer discrete cooking surfaces 160, the discrete cooking surfaces 160 may be larger. In one embodiment, the one or more discrete cooking surfaces 160 are evenly spaced around the continuous raised interior wall 150. In another embodiment, the one or more discrete cooking surfaces 160 are unevenly spaced around the continuous raised interior wall 150. In one embodiment, each discrete cooking surface 160 extends substantially over the entire vertical distance of the continuous raised interior wall 150, extending from the bottom portion 120 to the rim portion 140 of the bowl-shaped cooking surface 110. In another embodiment, each discrete cooking surface 160 is raised from between approximately one to five inches above the bottom portion 120 of the bowl-shaped cooking surface 110. In some embodiments, each discrete cooking surface 160 reaches to a point approximately one to five inches below the rim portion 140 of the bowl-shaped cooking surface 110.

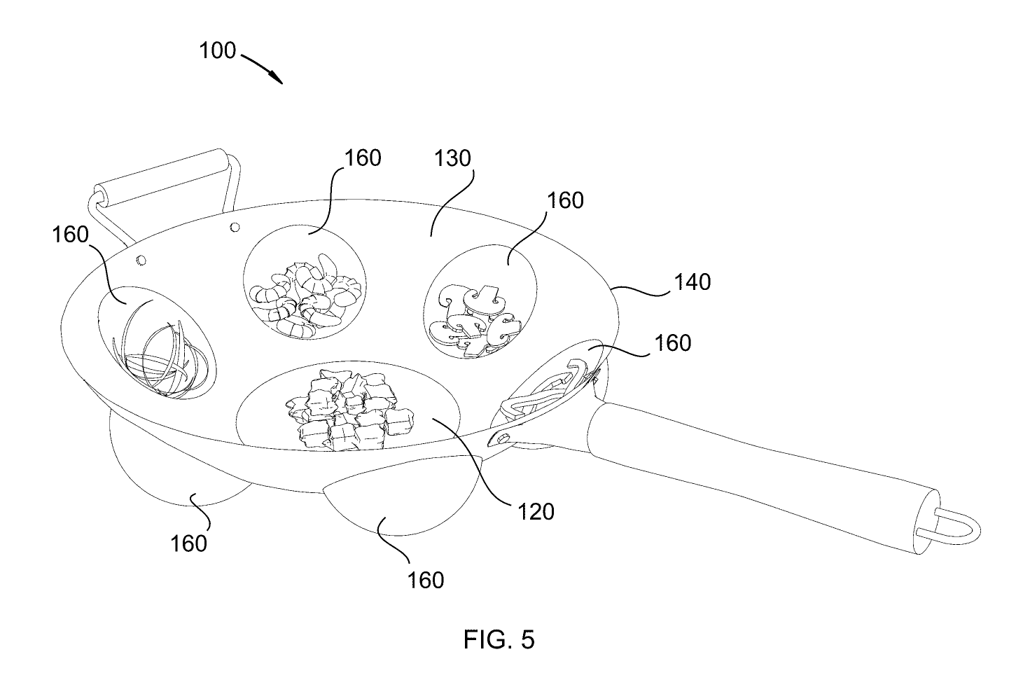

FIG. 5 depicts the wok-style pan 100 with some foods cooking on the bottom portion 120, and other foods separated into the one or more discrete cooking surfaces 160. In one embodiment, each of the one or more discrete cooking surfaces 160 constitute containers that hold objects, such as food particles, separate and apart from the contents contained by the bottom portion 120 of the bowl-shaped cooking surface 110. In one embodiment, the one or more discrete cooking surfaces 160 each have a volume of between about one-third cup to five cups. Each of the one or more discrete cooking surfaces 160 is large enough to contain and hold food particles, such as cut vegetables or meat. Cooking temperatures of the one or more discrete cooking surfaces 160 are lower than cooking temperatures of the bottom portion 120 and the intermediate portion 130 of the bowl-shaped cooking surface 100. In one embodiment, cooking temperatures of the one or more discrete cooking surfaces 160 are warming temperatures. In one embodiment, cooking temperatures of the one or more discrete cooking surfaces 160 are about 140 degrees Fahrenheit. Generally, the one or more discrete cooking surfaces 160 are exposed only to indirect heat when the bottom portion 120 is exposed to direct heat. This allows raw ingredients to remain only slightly cooked when placed in the one or more discrete cooking surfaces 160, until retrieved from the one or more discrete cooking surfaces 160 and removed to the bottom portion 120 of the wok-style pan 100 to be cooked at higher temperatures. Therefore, foods that may need to be cooked for shorter times can still be placed in the wok-style pan 100 at the same time as longer-cooking foods, but are not overcooked, if they are separated into the one or more discrete cooking surfaces 160. Furthermore, ingredients that have been cooking at the bottom portion 120 may be removed to the one or more discrete cooking surfaces 160 to remain heated, without continuing to overcook within the bottom portion 120 with other ingredients that may need to cook longer.

FIG. 6A-FIG. 6C depict embodiments of the wok-style pan 100 with a heating device. The heating device may be a custom heating device. The embodiment of the wok-style pan 100 with a bottom portion 120 comprising a concave surface, which cannot rest unassisted on a level surface, such as a stove top, can be used with a heating device. FIG. 6A depicts the wok-style pan 100 with a hot plate 600. In one embodiment, the hot plate 600 is equipped with a dial 610, which allows a user to select and adjust cooking temperatures. The hot plate 610 may be powered electrically, with an electrical power cord, or by battery or by propane. FIG. 6B depicts a front view of one embodiment of a wok-style pan 100 that is electric. In this embodiment, the wok-style pan 100 comprises a heating element 620. The heating element 620 may comprise coils located on the underside of the wok-style pan 100. The heating element 620 may also comprise an oil core. In one embodiment, the heating element 620 may comprise feet 640, or a base that houses the heating element 620, which support and suspend the wok-style pan 100. In one embodiment, each of the one or more discrete cooking surfaces 160 may also comprise a small heating element 660. In one embodiment, the heating element 620 may comprise wires 650 that run to each of the one or more discrete cooking surfaces 160. In one embodiment, the heating element 620 may comprise wires 650 that run to each of the small heating elements 660 of each of the one or more discrete cooking surfaces 160. In one embodiment, the heating element 620 may comprise a first temperature control 630, which allows a user to adjust the temperature of the heating element 620, and thus the cooking temperatures to which the bottom portion 120 of the wok-style pan 100 is exposed. In one embodiment, the heating element 620 may comprise a second temperature control 660, which allows a user to adjust the temperature of each of the small heating elements 660 of each discrete cooking surface 160. In this way, cooking temperatures of the one or more discrete cooking surfaces 160 can be maintained at warming temperatures, or at about 140 degrees Fahrenheit. Cooking temperatures of the one or more discrete cooking surfaces 160 are lower than cooking temperatures of the bottom portion 120 and the intermediate portion 130 of the bowl-shaped cooking surface 100. FIG. 6C depicts a bottom view of one embodiment of a wok-style pan 100 that is electric comprising a heating element 620. The heating element 620 may comprise coils 690 located on the underside of the wok-style pan 100. The heating element 620 may be a 1500 W heating element. The heating element 620 may be a butterfly heating element. The heating element 620 may be connected to an electrical power cord 670 and powered by electricity. The heating element 620 may be equipped with a heat shield 680. In one embodiment, each of the one or more discrete cooking surfaces 160 may also comprise a small heating element 660. In one embodiment, the heating element 620 may comprise wires 650 that run to each of the one or more discrete cooking surfaces 160. In one embodiment, the heating element 620 may comprise wires 650 that run to each of the small heating elements 660 of each of the one or more discrete cooking surfaces 160.

FIG. 7 depicts one embodiment of a wok-style pan 100 comprising one or more lids. In one embodiment, the wok-style pan 100 comprises a top lid 700 that fits tightly within the rim portion 140 of the bowl-shaped cooking surface 110. The rim portion 140 may be configured to accommodate a top lid 700 for the wok-style pan 100. The top lid 700 may be high-domed. The top lid 700 may comprise glass, plastic, metal, or another material. The top lid 700 may comprise one or more handles 710. In one embodiment, the wok-style pan 100 may comprise one or more small lids 720 for the one or more discrete cooking surfaces 160. The one or more small lids 720 may sit on top of the one or more discrete cooking surfaces 160 or they may fit tightly within the one or more discrete cooking surfaces 160. The one or more small lids 720 may comprise metal, glass, wire mesh, or another material. The one or more small lids 720 may be high-domed or flat. The one or more small lids 720 may keep heat in or out of the area of the one or more discrete cooking surfaces 160.

1. A wok-style pan comprising:
a bowl-shaped cooking surface comprising a bottom portion, an intermediate portion, and a rim portion, the intermediate portion comprising a continuous raised interior wall joining the bottom portion and the rim portion, and the continuous raised interior wall comprising one or more discrete cooking surfaces disposed thereon, wherein cooking temperatures of the one or more discrete cooking surfaces are lower than cooking temperatures of the bottom portion and the intermediate portion.

2. The wok-style pan of claim 1, wherein the bottom portion comprises a concave surface.

3. The wok-style pan of claim 1, wherein the bottom portion comprises a planar surface.

4. The wok-style pan of claim 1, wherein the continuous raised interior wall inclines from the rim portion to the bottom portion at a concave slope.

5. The wok-style pan of claim 1, comprising cast iron, or carbon steel, or stainless steel, or a combination thereof.

6. The wok-style pan of claim 1, wherein the bowl-shaped cooking surface is three to ten inches deep, measured vertically from the rim portion to the bottom portion.

7. The wok-style pan of claim 1, wherein the continuous raised interior wall extends entirely around the bowl-shaped cooking surface.

8. The wok-style pan of claim 1, wherein the bowl-shaped cooking surface comprises an exterior surface comprising one or more handles.

9. The wok-style pan of claim 8, wherein the one or more handles are loop-style handles.

10. The wok-style pan of claim 8, wherein the one or more handles are stick-style handles.

11. The wok-style pan of claim 1, wherein the one or more discrete cooking surfaces comprise depressions in the intermediate portion opening into the interior of the pan.

12. The wok-style pan of claim 1, wherein the one or more discrete cooking surfaces in the intermediate portion are substantially bowl-shaped opening into the interior of the pan.

13. The wok-style pan of claim 1, wherein the one or more discrete cooking surfaces comprise a shelf along an interior surface of the intermediate portion.

14. The wok-style pan of claim 1, wherein the one or more discrete cooking surfaces comprise a substantially oval depression comprising a flattened bottom surface.

15. The wok-style pan of claim 1, wherein the one or more discrete cooking surfaces each have a volume of between about one-third cup to five cups.

16. The wok-style pan of claim 1, wherein the one or more discrete cooking surfaces are evenly spaced around the continuous raised interior wall.

17. The wok-style pan of claim 1, comprising six discrete cooking surfaces.

18. The wok-style pan of claim 1, comprising four discrete cooking surfaces.

19. The wok-style pan of claim 1, further comprising a heating element.

20. The wok-style pan of claim 1, wherein each of the one or more discrete cooking surfaces comprises a heating element.
